(19) United States
(12) Patent Application Publication
(10) Pub. No.: US 2004/0042099 A1
(43) Pub. Date: Mar. 4, 2004

(54) Blind spot mirror

(76) Inventors: William L. Libby, Golden (CA); Dianne N.L. Libby, Golden (CA)

Correspondence Address: ADE & COMPANY, 1700-360 MAIN STREET, WINNIPEG, MB, R3C3Z3, CA

(21) Appl. No.: 10/232,630

(22) Filed: Aug. 30, 2002

(51) Int. Cl. G02B 7/182

(52) U.S. Cl. 359/876; 248/467; 248/481

(57) ABSTRACT

An auxiliary rear view mirror comprising a housing with a rear side and a front side, a mirror on the front side and a mounting arrangement rotatably coupled to the rear side of the housing arranged for attaching the mirror to a rear view mirror on a vehicle. The mounting arrangement has a flat pad arranged to be adhesively attached to the rear view mirror and has an arm extending from a respective side of the pad. The arm has a ball end arranged to be received by a socket on the auxiliary mirror such that the mirror can be tilted and rotated about the pad.

### FIELD OF THE INVENTION

The present invention relates to a blind spot mirror arranged to be mounted to a rear view mirror of a vehicle.

### BACKGROUND

Rear view and side view mirrors on vehicles, specifically cars and such, provide a driver with a view of an area behind the vehicle. Standard mirrors on these vehicles provide an adequate view but also have what is known as a “blind spot.” These “blind spots” are usually located in an area in which the rear view mirror and the side view mirror can not view. It is necessary for a driver to “shoulder check” when merging into lanes or the like.

Accessories have been made to eliminate the “blind spot” by using an extra mirror which can be placed in a position to view the “blind spot.” Some examples of this is found in U.S. Pat. No. 4,802,751 (Ueng) which provides a mirror arranged to be clamped to a standard mirror and is arranged to be angled to view the blind spot. The mirror has a flat lens and forces the user to shift eye contact from mirror to mirror. This angled shifting view can be a hindrance to a driver.

Another example is shown in U.S. Pat. No. 5,106,177 (Dolasia) which uses clamps to mount to the mirror and is disclosed as being mainly used for surveillance. If the disclosed invention was to be clamped to a side view mirror is may not be effective in that it could block the view of the standard mirror and cannot be deflected or positioned to avoid objects.

Another example is shown in U.S. Pat. No. 4,980,908 (Casey) discloses a mirror which extends outside the mirror perimeter and it may not be positioned within the perimeter of the mirror for used during a car wash or the like and the mirror also has limited movement if engaged by an object.

Another example is shown in U.S. Pat. No. 5,691,855 (Lupkas) and U.S. Pat. No. 4,932,769 (Goosen) show a flat mirror which would obstruct the view from the standard mirror.

Another example is shown in U.S. Pat. No. 4,793,701 (Brown) which adhesively attaches to a rear side of the mirror. It does not allow deflecting movement when struck by an object and has limited movement. Any of the movement is provided by the flexible bar mounting arrangement.

Another example is shown in U.S. Pat. No. 6,132,051 (Morell et al) which is arranged to couple to an interior rear view mirror using a C-clamp.

Another example is shown in U.S. Pat. No. 5,748,395 (Rendi Jr.) discloses a mirror which is mounted within the existing housing of a standard interior rear view mirror.

### SUMMARY

According to the present invention there is provided an auxiliary rear view mirror comprises:

a housing having a rear side and a front side;

a mirror on the front side; and,

a mounting arrangement rotatably coupled to the rear side of the housing arranged for attaching the mirror to a rear view mirror on a vehicle;

wherein the mounting arrangement has a flat pad arranged to be adhesively attached to the rear view mirror;

wherein the mounting arrangement has an arm extending from a respective side of the pad;

wherein the arm has a ball end arranged to be received by a socket on the auxiliary mirror.

Preferably the socket has a recess such that the ball can be tilted therein providing deflective movement to the auxiliary mirror.

Preferably the ball is arranged to rotated within the socket providing 360° rotation of the mirror.

### BRIEF DESCRIPTION OF THE DRAWINGS

In the accompanying drawings, which illustrate an exemplary embodiment of the present invention:

FIG. 1 shows a front elevational view of the present invention without a convex mirror.

FIG. 2 shows an isometric view of the present invention without a convex mirror.

FIG. 5 shows a top view of the present invention.

FIG. 6 shows a side elevational view of one part of the mounting arrangement of the present invention.

FIG. 7 show a rear view of one part of the mounting arrangement of the present invention.

FIG. 8 shows a side view of the present invention mounted on a rear view mirror in a viewing position.

FIG. 9 shows a side view of the present invention mounted on a rear view mirror in a retracted position.

FIG. 10 shows a side view of the present invention mounted on a rear view mirror in a rearward position.

FIG. 11 shows a side view of the present invention mounted on a rear view mirror in an angled position.

### DETAILED DESCRIPTION

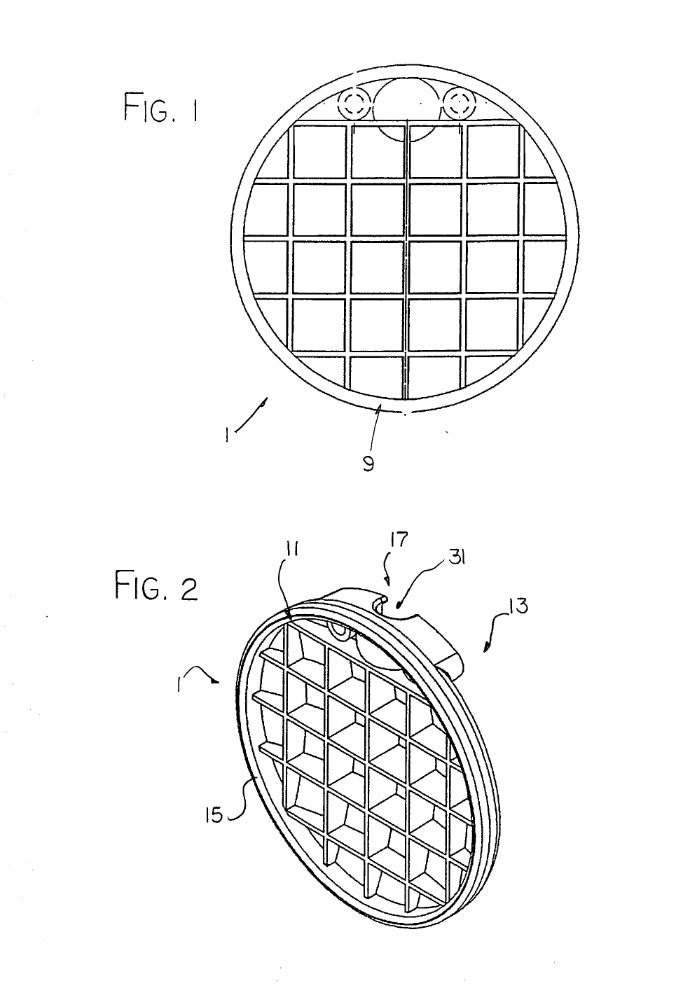

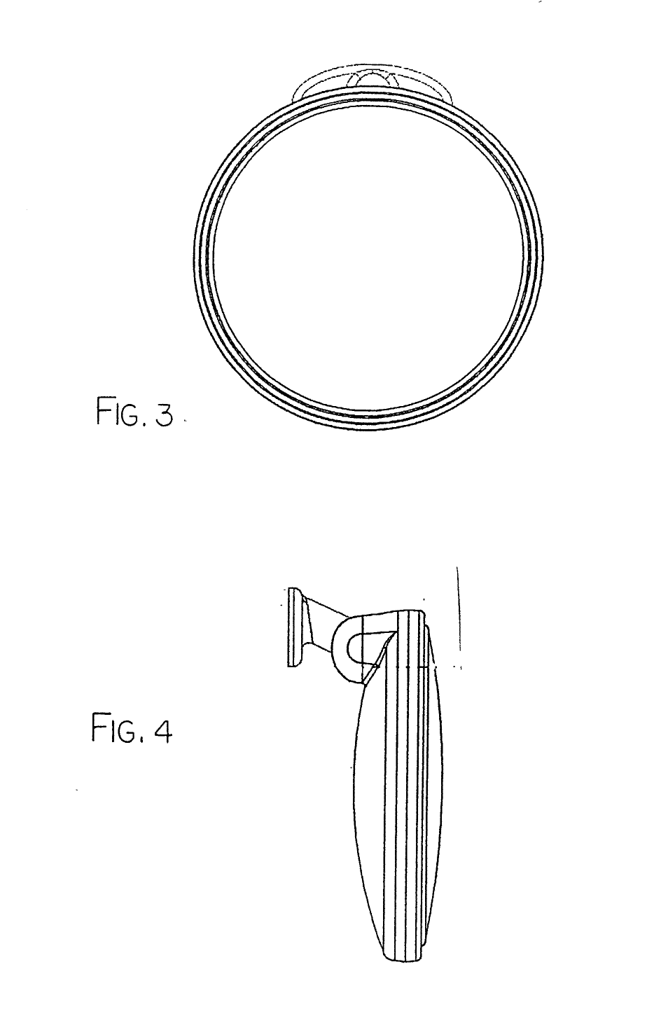

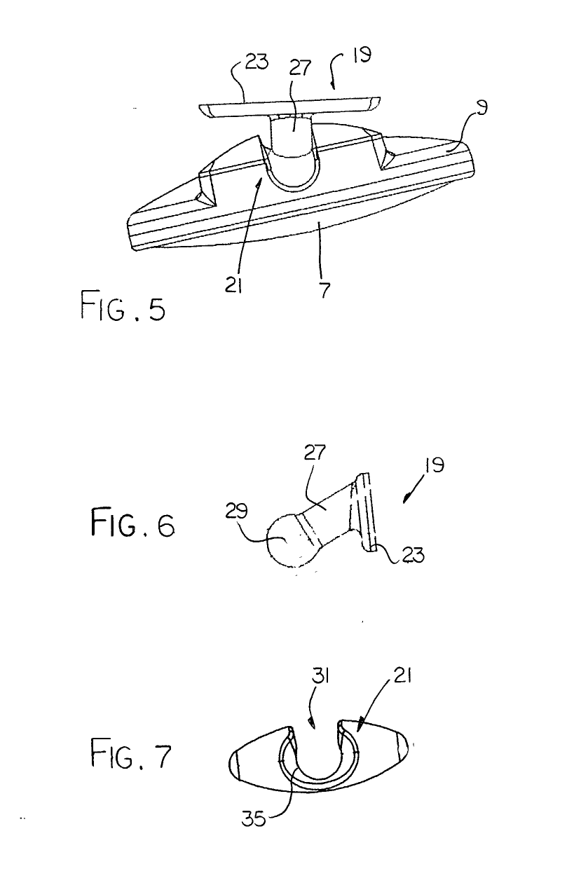

Referring to the accompanying drawings, there is illustrated auxiliary side view mirror 1 arranged to be attached to a standard side view mirror 3 on a vehicle 5. The auxiliary mirror is arranged to provide a driver with an expanded field of vision. The auxiliary mirror has a convex lens 7 which provides the driver with a view which allows sight of the vehicles blind spots. FIGS. 1 and 2 show the shape of the mirror. A mirror mount 9 has a disk shape. The mount has a front side 11 and a rear side 13. The front side is arranged to face in a rearwards direction on the vehicle and is arranged to receive the convex lens. The size of the auxiliary mirror is smaller than the standard mirror on the vehicle and is arranged not to inhibit the view of the standard mirror. The mirror mount has an outer lip 15 on the front side arranged to support the convex mirror therein. The mirror is moulded out of plastic. The auxiliary mirror has a socket housing 17 at an edge of the mount for connection to a mirror mounting arrangement 19, as described later in detail. The mounting arrangement is arranged such that the mirror has rotational movement for adjustment of the mirror as well as for deflection when engaged by an object such as when the vehicle is put through a car wash. The socket housing is on the rear side of the mirror mount and has a socket 21.

The mounting arrangement, as best illustrated in FIG. 6, is arranged to be received by the socket. The mounting arrangement has a flat pad 23 which is arranged to be adhesively attached to a front side of the standard mirror on the vehicle. The pad is arranged to take up a minimal amount of standard mirror surface such that there is minimal obstruction of the view through the standard mirror. An arm 27 extends at an angle from the pad away from the mirror such that positioning of the pad on the mirror is situated whereby the arm extends in a direction away from the mirror and out of the viewing area thereon. The outermost end of the arm has a ball 29 which is arranged to be receive in the socket. The ball provides the auxiliary mirror with the rotational movement.

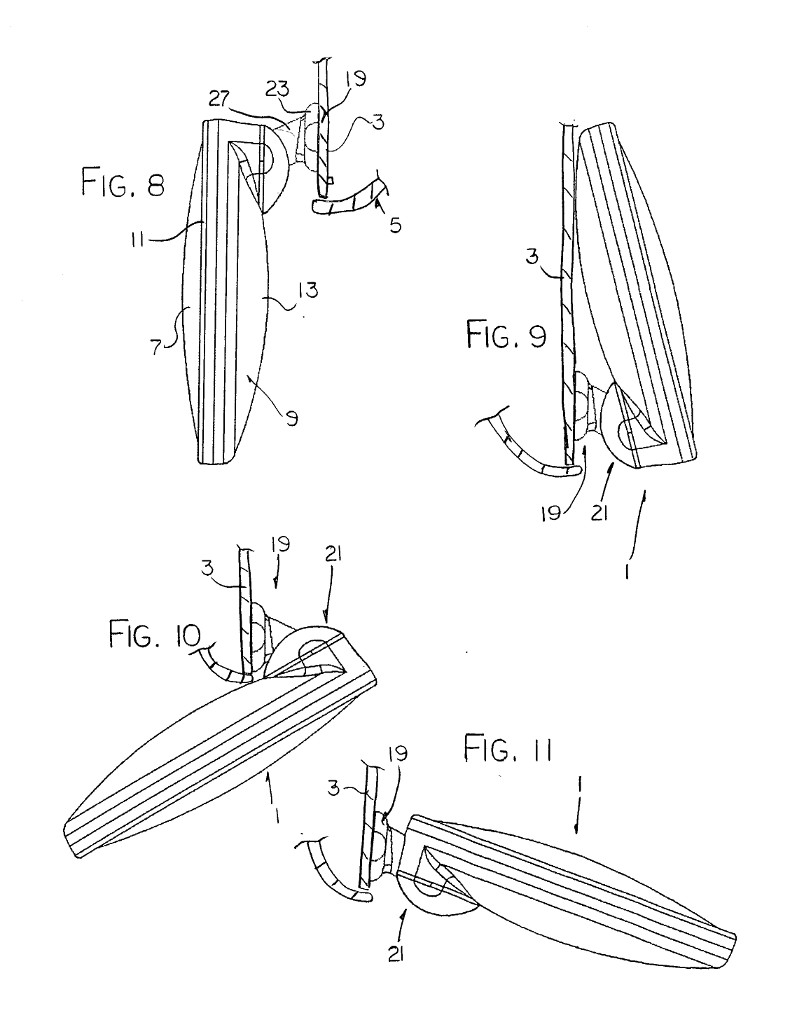

The socket has a recess 31 at a top end or outer end thereof such that the auxiliary mirror can be tilted to be co-linear with the arm allowing the mirror to be able to deflect inwards into the perimeter of the mirror, as illustrated in FIG. 9. The ball and socket allow 360° rotation of the auxiliary mirror thereon, as shown in FIGS. 8-11. FIG. 9 shows the auxiliary mirror in the retracted position whereby the socket is rotated such that the auxiliary mirror is positioned within the perimeter of the standard mirror. The retracted position allows the auxiliary mirror to safely be attached as the vehicle is put through a car wash or the like. FIG. 10 shows the auxiliary mirror in the rearward deflected position and FIG. 11 shows the auxiliary mirror in the forward deflected position. The rearward deflected position is provided by an outer recess 35 about the socket which expands the area in which the arm can be located. The deflected positions provide the auxiliary mirror with mobility when engaged or struck by an object.

While one embodiment of the present invention has been described in the foregoing, it is to be understood that other embodiments are possible within the scope of the invention. The invention is to be considered limited solely by the scope of the appended claims.

1. An auxiliary rear view mirror comprises:
a housing having a rear side and a front side;
a mirror on the front side; and,
a mounting arrangement rotatably coupled to the rear side of the housing arranged for attaching the mirror to a rear view mirror on a vehicle;
wherein the mounting arrangement has a flat pad arranged to be adhesively attached to the rear view mirror;
wherein the mounting arrangement has an arm extending from a respective side of the pad;
wherein the arm has a ball end arranged to be received by a socket on the auxiliary mirror.

2. The mirror according to claim 1 wherein the socket has a recess such that the ball can be tilted therein providing deflective movement to the auxiliary mirror.

3. The mirror according to claim 1 wherein the ball is arranged to rotated within the socket providing 360° rotation of the mirror.
